(19) United States
(12) Patent Application Publication
(10) Pub. No.: US 2014/0274115 A1
(43) Pub. Date: Sep. 18, 2014

(54) TRACKING DEVICE AND REMOTE MONITORING SYSTEM

(71) Applicant: Grid-Roots, LLC, Newcastle, NH (US)

(72) Inventors: William R. Michalson, Douglas, MA (US); Lukas Kolm, New Castle, NH (US); John R. Trayner, Hampton, NH (US); Ryan J. DesRoches, North Grosvenordale, CT (US)

(73) Assignee: Grid-Roots, LLC, Newcastle, NH (US)

(21) Appl. No.: 13/836,528

(22) Filed: Mar. 15, 2013

(51) Int. Cl. H04W 4/02

(52) U.S. Cl. CPC H04W 4/028
USPC 455/456.1

(57) ABSTRACT

A system includes a remote monitoring device configured to detect and measure one or more signals and to convey detected and measured signal information to a central location. The central location is configured to determine the location of the remote monitoring device based on the received signal information and is also configured to determine at least one hypothetical path of the remote monitoring device.

### BACKGROUND OF THE INVENTION

During the past several years there has been unprecedented growth in applications of location technologies such as the Global Positioning System (GPS), Assisted-GPS (AGPS), Cellular Radio-based location determination and others. Location determination is typically performed using known techniques such as measuring the time of arrival (TOA) of radio signals between source and destination, using time-difference of arrival (TDOA), angle of arrival (AOA), received signal strength indicators (RSSI) or some combination of these measurements to estimate the range and/or bearing between the source(s) and destination(s) of a radio signal. Using these estimates of range and/or, it is then possible to use known techniques such as triangulation, multilateration, trilateration and such to determine the absolute location of a device relative to some desired coordinate system (for example, latitude and longitude). While the coordinate system used is arbitrary, for example latitude and is longitude referenced to WGS-84, the positioning principles within the chosen coordinate system are essentially the same.

Another technique for determining position is the technique known as “dead-reckoning.” This technique relies on measurements such as speed, bearing, acceleration, angular rate of rotation and the like to determine how an object is moving based on the laws of physics. For example, if acceleration in three dimensions is measured using accelerometers, then velocity in each of the three dimensions can be determined by integrating acceleration over time. Systems which operate on these principles are often referred to as inertial navigation systems (INSs) while the raw measurements are made in an inertial measurement unit (IMU). It is common today to see multiple inertial measurement devices such as accelerometers, gyroscopes and magnetometers combined into devices called attitude and heading reference systems (AHRS). Such combinations may or may not include radio navigation devices such as a GPS receiver.

While radio navigation systems and inertial navigation systems such as those described above are well-known in the art, they are not without difficulties.

For example, the GPS, while highly effective in outdoor environments, is ineffective when used indoors or underground because of problems associated with signal attenuation and multipath. Cellular-radio and Assisted GPS work well in some environments, but again lose their effectiveness when signal levels are poor or there is substantial multipath in the environment. Inertial systems can be highly accurate, but rely on the availability of an accurate initial position to project forward in time. Additionally, low-cost inertial systems tend to accumulate significant amounts of error due to factors such as DC bias, drift and temperature sensitivity.

Therefore, while there have been, and continue to be, important advancements for all of these location determining technologies, there is no one technology or combination of technologies that works well to determine position in both indoor and outdoor environments. In the context of this discussion, the term indoor is taken to include all environments which result in poor signal quality, multipath or other interference.

Thus, there remains a tremendous unmet need and want, where people, businesses and institutions wish to establish the whereabouts and anticipated destinations of people or similarly regarded assets even when those people or assets are in locations where current location technologies are ineffective.

### BRIEF SUMMARY OF THE INVENTION

Known commercial location devices rely on the GPS and/or the cellular systems. These devices do not exploit the variety of network signals, such as GPS, Cellular, Bluetooth, Wi-Fi and others that are available for determining position. Further, they do not exploit knowledge about the networks and the environments the tracking devices are operating in to aid in refining their knowledge of position.

The device disclosed herein is envisioned as a device that enables businesses to track assets, parents to track the location of their children, caregivers to track the location of patients, and so on, using a combination of technologies interconnected through a hierarchical set of networks referred to as the “virtual grid.”

In the context of this patent specification, this virtual grid, or simply “grid” refers to signals of opportunity that can be used for determining position and/or for providing communications between devices. For example, signals from the global positioning system, or GPS, form a part of the grid that can be used to calculate position whereas cellular signals may be used to determine position using the cellular network as well as for bidirectional communications between devices. Thus, of the many signals that may be present in a given environment, some may be exploitable for position determination, some may be exploitable for providing a communications capability, and some may be exploitable for providing both a position determination and a communications capability. These signals form a part of the virtual grid, or grid. Further, a “connection to the grid” refers to actual exploitation of one of more of the signals of opportunity in a device's environment. Examples of such a connection to the grid include, without limitation, reception and use of GPS signals when such signals are available, establishing an authenticated communications link through a cellular network, reception of Wi-Fi, Bluetooth, AM/FM/TV broadcast signals, access to unsecured Wi-Fi access points and the like.

Thus, at its highest level, the grid can be considered a network of networks that exploits the unique characteristics of the different types of available network connections to assist in position determination and/or to provide communications connectivity to other parts of the grid. By combining display technologies such as Google Maps, MapQuest, Bing, or other similar map technology providers, with personal computers and smart phone applications, the planned device will provide peace of mind for parents by enabling them to instantaneously determine their child's location and to receive alerts if the child becomes lost or strays from an expected location. Typical applications for the remote monitoring device in accordance with one or more embodiments of the present invention, include the ability to: locate and monitor children with cognitive disabilities who become lost, reunite families that become separated in an amusement park, relieve anxieties caused by a child not being at an expected location at a designated pick-up time and many other applications. Additional extensions to the developed technology are to provide additional security to the elderly, handicapped and others who wish to maintain their independence but who will also recognize the benefits of allowing caregivers to know where they are, collect statistics of wait times at attractions in a theme park, determine if people are entering unauthorized areas and other applications.

### BRIEF DESCRIPTION OF THE SEVERAL VIEWS OF THE DRAWINGS

Embodiments of the present invention may be better understood by referring to the following description in conjunction with the accompanying drawings in which:

FIG. 1. is a functional block diagram of a remote monitoring device in accordance with one embodiment of the present invention;

FIG. 2. is a functional block diagram showing remote monitoring devices and a server connected to the grid in accordance with one embodiment of the present invention;

FIG. 3. is an overview of the grid concept in accordance with one embodiment of the present invention;

FIG. 4. is a representation of the grid as a collection of networks in accordance with one embodiment of the present invention;

FIG. 5. is a representation of a conventional approach for determining position of a remote monitoring device;

FIG. 6a. is a representation of an indoor environment containing multiple network access points and their radio coverage areas in accordance with one embodiment of the present invention;

FIG. 6b. is a representation of determining estimated remote monitoring device path based on heuristic evaluation of data collected by a remote monitoring device in accordance with one embodiment of the present invention;

FIG. 7. is a functional block diagram of the grid as an ad hoc collection of spatially distributed networks in accordance with one embodiment of the present invention;

FIG. 8. is a flowchart of a method in accordance with one embodiment of the present invention; and

FIG. 9. is a flowchart of a method of operation of remote monitoring device in accordance with one embodiment of the present invention.

### DETAILED DESCRIPTION OF THE INVENTION

In the following detailed description, numerous specific details are set forth in order to provide a thorough understanding of the embodiments of the present invention. It will be understood by those of ordinary skill in the art that these embodiments of the present invention may be practiced without some of these specific details. In other instances, well-known methods, procedures, components and structures may not have been described in detail so as not to obscure the embodiments of the present invention.

Referring to FIG. 1, the remote monitoring device (RMD) 100 is the portion of the system that is attached to, or otherwise carried by, the person or asset that is being tracked and/or monitored. In one embodiment, remote monitoring device 100 contains a position determining device, such as GPS receiver 102, or the like, which yields an absolute position such as a latitude and longitude; a Cellular radio 104 which allows for computing position using techniques known in the art such as TOA, TDOA, AOA (including providing assistance data for improving the performance of GPS receiver 102) which also yields an estimate of absolute position; other radio-based techniques using Bluetooth radio 106 or other radio 108 for making range, angle of arrival, RSSI or other measurements to derive absolute position or to find position relative to some fixed reference point in the environment; dead-reckoning from a known or calculated location based on inertial measurements from IMU 109; or combinations of these positioning devices as are known in the art. For example, in one embodiment, the device of FIG. 1 could be implemented as a so-called smart phone such as an iPhone, Android phone or other similarly equipped devices as are known in the art.

GPS antenna 101 is electrically connected to GPS receiver 102 using coaxial cable or other connection appropriate for the particular antenna and receiver being used (for example, a wire or micro strip connection). GPS receiver 102 may be implemented using GPS devices known in the art, or may consist of the RF components necessary to receive a GPS signal while the remainder of the GPS receiver is implemented in software on processor 110. This alternate implementation is often referred to as a software defined radio (SDR).

Processor 110 is a microprocessor or microcontroller as is known in the art. If processor 110 is implemented as a microcontroller, then the necessary read-only memory (ROM), random access memory (RAM) and input/output (IO) interfaces to other system components are typically incorporated into a single device. If processor 110 is implemented as a microprocessor, then the necessary RAM, ROM, IO and other interfaces to system components may be implemented in multiple devices as is known in the art. Regardless of the specific implementation, processor 110 contains the computing resources and interfaces needed to support the operations of the remote device. Examples of suitable processors include processors such as the Intel Atom, Cortex M-series or ARM-series processors.

Similarly, cellular antenna 103 is connected to cellular radio 104 using coaxial cable or other connection appropriate for the particular antenna and receiver being used as outlined above. Cellular radio 104 may be implemented using cellular devices known in the art, or may consist of the RF components necessary to implement the cellular radio as an SDR using the computing resources of processor 110.

Bluetooth antenna 105 is connected to Bluetooth radio 106 using coaxial cable or other connection appropriate for the particular antenna and receiver being used as outlined above. Bluetooth refers to a radio operating in accordance with the Bluetooth standard as is known in the art. Bluetooth radio 106 may be implemented using cellular devices known in the art, or may consist of the RF components necessary to implement the Bluetooth radio as an SDR using the computing resources of processor 110.

The other radio antenna 107 is connected to other radio 108 using coaxial cable or other connection appropriate for the particular antenna and receiver being used as outlined above. In this case the other radio 108 may include one or more additional radio transmitters and/or receivers configured to provide connectivity between the remote device and other devices or configured to provide positioning information. This radio may be a standard 802.11-type radio designed to adopt one or more of the known Wi-Fi standards or other radio transmitters and receivers designed to support known or future radio standards. In one embodiment, other radio 108 may be configured to receive multiple signals of opportunity such as AM, FM or television transmissions. From such transmissions, other radio 108 may extract the carrier and use this carrier phase information to determine the relative phase offsets of the various signals. This phase difference information can then be used to determine range from known transmitter locations and thus determine an estimate of the position of remote monitoring device 100. In other embodiments other radio 108 may provide communications services such as a digital radio channel using, for example, the P25 protocol common in public safety radio systems. This other radio 108 may be implemented using devices known in the art, or may consist of the RF components necessary to implement the other radio as an SDR using the computing resources of processor 110.

In addition to radio connectivity, remote monitoring device 100 may contain inertial measurement unit (IMU) 109 which allows the measurement of inertial quantities such as acceleration and angular rate of change. In general, the IMU 109 will measure the acceleration along the three orthogonal X, Y and Z-axes of remote monitoring device 100. Additionally, the IMU 104 may use one or more gyroscopes to allow measuring the rate of rotation about the X, Y and/or Z-axes of remote monitoring device 100. Optionally, IMU 109 may include other sensors to detect motion such as magnetic sensors to determine X, Y and/or Z bearing of remote device 100, odometry sensors to determine speed and/or direction of travel, or other sensors for the purpose of detecting movement of the remote monitoring device 100 known in the art.

In addition to sensors for determining position and/or motion of remote monitoring device 100, other sensors 115 may be included to allow monitoring the status and/or activity level of the person or asset carrying remote monitoring device 100. These other sensors 115 include, but are not limited to, environmental sensors for sensing environmental parameters such as temperature, humidity, pressure and the like; physiological sensors for sensing physiological parameters such as heart rate, blood oxygen level, respiration rate, blood pressure and the like; other sensors and/or actuators such as switches, lighted indicators, alarms, loudspeakers and the like. For example, wrist-wearable devices such as the Garmin Forerunner series, the Suunto Ambit and Quest series watches provide the ability to monitor physical parameters. Such devices could be integrated with the resources of remote monitoring device 100 to allow these devices to continue to track position using the resources of the grid. Additionally, in such an integration, the communications resources of the grid can be used to remotely monitor the physical status of wearer. In other embodiments remote monitoring device 100 is combined with a Holter Monitor in order to remotely monitor ECG or EEG signals using the communications resources of the grid.

Computer port 111 provides access to supply power to charger circuit 112 for charging battery 113 and may optionally provide access to processor 110 for purposes of uploading configuration information, programming, downloading collected data, upgrading or otherwise communicating between processor 110 and an external computer system either attached directly or in a network e.g., the Internet (not shown). In one embodiment, computer port 111 is configured to support the universal serial bus (USB) standard for serial communication but may optionally be configured to communicate using Ethernet, RS-232, CAN or other communications techniques known in the art.

Power supply 114 converts the voltage of battery 113 (or, optionally of charger 112) into the voltages needed by other system components using techniques known in the art.

Referring to FIG. 2, the manner in which the remote monitoring devices 100 interact with the system in accordance with one embodiment of the present system is illustrated. In one embodiment, one or more remote monitoring devices 100 connect to the grid 201 in a manner analogous to the way in which a cellular telephone connects to the cellular network to allow communications with server 204.

For example, when using cellular radio 104 to communicate using the resources of the grid, cellular radio 104 initiates a wireless connection 202, for example using the GSM protocol, with a cellular provider using established procedures. Once a connection to the network is established, remote monitoring device 100 initiates a virtual connection, for example, using the transmission control protocol (TCP) or the unreliable datagram protocol (UDP) to establish a communications path through grid 201 to server 204. In this case, a virtual connection is considered to be a communications path between remote monitoring devices 100 and server 204 that is established even though remote monitoring device 100 and server 204 are not physically interconnected.

Other embodiments would establish such a virtual connection using techniques analogous to the embodiment described above that are appropriate for the technology being applied. For example, rather than using cellular radio 104 and the GSM protocol to establish wireless connection 202, one could alternatively use other radio 108 and any of the various Wi-Fi protocols known in the art.

In another embodiment, connection to the grid may detect cellular radio signals for use in determining approximate position without authenticating to the cellular network to open a communications channel. In such an embodiment, cellular signals may be detected and analyzed, but the data extracted from the detected signals may be stored for later use or communicated through an alternate communications path such as a Wi-Fi connection.

Any arbitrary number of individuals or assets may carry at least one remote monitoring device 100 and may connect to grid 201. Therefore, a large number of connections to grid 201 and/or server 204 may be active at any one time. Further, although server 204 is illustrated as a single server computer, it would be understood by one of skill in the art that server 204 may include multiple server computers at the same, or at multiple, physical locations. Connections to grid 201 and/or server 204 may be handled simultaneously in situations where sufficient parallelism exists in the system to allow truly simultaneous connections, may be multiplexed in time, may be multiplexed in frequency, or may be otherwise managed in accordance with known techniques for arbitrating the allocation of limited resources among multiple devices.

Server 204 connects to grid 201 using connection path 203. In one embodiment, connection 203 is a virtual connection representing the connection between server 204 and the grid 201, thus facilitating communications between server 204 and remote monitoring devices 100. In one embodiment, this virtual connection occurs when TCP and/or UDP communications between server 204 and remote monitoring devices 100 are established via Internet connection 203.

In other embodiments, connection 203 may be implemented in any manner that allows server 204 to interact with remote monitoring devices 100 regardless of the physical characteristics of the connection or the protocols used to establish the virtual connection.

In general, server 204 may support one or more users 206. Each user connects to server 204 using connection 205. In one embodiment server 204 is an IBM-compatible personal computer running the Ubuntu Linux operating system, connection 205 is a wired Ethernet connection and users 206 connect to server 204 through web-based application code operating in conjunction with a web server application such as the well-known Apache HTTP server software. One of skill in the art would know of many equivalent ways to allow multiple users to interact with server 204 such as by using other Linux variants, Unix, SunOS, Microsoft Server and other multi-user server software. Similarly, while HTTP servers such as Apache are commonly used for Internet-connected servers, other techniques such as using a private intranet or virtual private network (VPN) would allow interacting with server 204 over connection path 203. It should be noted that due to the geographic extent of the grid, and the potentially large number of users, server 204 could, in one embodiment, be implemented as a distributed computer system including a plurality of server computers operating as a distributed system which includes a distributed database.

FIG. 3 illustrates the concept of grid 201. As outlined above, one of the fundamental problems with current remote monitoring systems is an inability to obtain location information that is sufficiently accurate to locate remote monitoring device 100 as it passes through areas with no signal reception, poor signal strength, high multipath, or other impediments to signal reception and/or transmission. Grid 201 combines a variety of different location determination technologies, allowing position of the RMD 100 to be determined using different techniques in different locations. In one embodiment, in situations where remote monitoring unit 100 has good visibility of the sky, the Global Positioning System (GPS) 304 may be used to determine position.

In transition regions, where GPS position variance exceeds a programmable accuracy threshold, i.e., the GPS positioning may be unreliable, position may be determined (or the GPS data may be augmented) using the cellular network 301 to provide cellular radio based position determination or cellular-assisted GPS positioning. As remote monitoring unit 100 travels into increasingly difficult radio navigation environments, local radio signals of opportunity may be used to provide a position determination resource. For example, signals received from a Wi-Fi enabled router 302 or Bluetooth device 303 can be used to determine an approximate position relative to the location of the Wi-Fi or Bluetooth access point by, for example, using received signal strength as a measurement of approximate distance from the access point. More sophisticated navigation techniques measure the time of flight between a receiver and multiple Wi-Fi or Bluetooth nodes in local network to estimate position in a manner analogous to that used in the GPS. In one embodiment using signals received from Wi-Fi access points, the location of the received access points may be retrieved from a database of known Wi-Fi access point locations. Such databases may be created by physically surveying the locations of access points, or by using Wi-Fi scanning as has been described by Skyhook Wireless.

In another embodiment, a Wi-Fi or Bluetooth network may be configured as a self-organizing ad hoc network in which each node of the network can determine the communications routing paths between nodes as nodes are deployed. In such a network, signals passed between nodes in the ad hoc network can be used to determine distance between neighboring nodes as well as distance between non-neighboring nodes. These distance measurements allow the ad hoc network to determine the relative location of each node with respect to an initial reference point. Once the relative locations of nodes in the network are known, the location of an RMD 100 within that network can be determined as described herein.

In still other environments where even local radio signals are unavailable, or not part of grid 201, inertial navigation may be performed using data obtained locally using IMU 109. Such inertial navigation techniques are well-known in the art.

FIG. 4 illustrates grid 201 as a hierarchy of networks in which a remote monitoring device 100a, 100b, 100c can connect to one or more nodes in the grid, where for purposes of illustration, a node is a grid resource, such as the GPS 304, cellular network 301, network 401a, 401b, 401c and/or 401d that can be used for determining the position of remote monitoring device 100 and/or can be used for transferring data between remote monitoring device 100 and other devices in the network (for example server 204). Similarly, in the context of the grid, a “connection” refers to the exploitation of a grid resource such as receipt of a GPS signal or the establishment of an authenticated communications path through a cellular network as described herein.

In FIG. 4, remote monitoring device 100a is shown as receiving signals 403 from the Global Positioning System satellites 304 (only one shown for purposes of illustration) that are received by GPS receiver 102. If the received GPS signals 403 are sufficiently strong to allow for acquisition and tracking of a sufficient number of satellite signals 403, then GPS receiver 102 can determine the location of remote monitoring device 100a. As is known in the art, a GPS receiver typically requires a minimum of four GPS satellites to determine position. However, once an initial position has been determined, it is possible to continue determining position with fewer than four satellites.

This ability to continue determining position with fewer than four satellites is improved when inertial measurements from IMU 109 are available. Observables such as, velocity and acceleration can be derived from the raw measurements provided by IMU 109. This velocity and acceleration data can be combined with information obtained from GPS receiver 102 in such a way as to improve position estimates even when fewer than four GPS satellites are available. For example, processor 110 can execute software to run the algorithms described by JA Rios in his paper “Low Cost Solid State GPS/INS Package,” (Symposium on Gyro Technology, 2000) or as described by Hide in “Adaptive Kalman Filtering Algorithms For Integrating GPS and Low Cost INS” (IEEE 2004 Position Location and Navigation Symposium) in order to determine a combined GPS/INS position estimate—the entireties of these papers are incorporated herein by reference.

It should be noted that the Global Positioning System has been used herein as an example. One of ordinary skill in the art would know that with respect to the description provided herein, other satellite positioning systems such as Galileo, GLONASS and others known in the art can be used in a substantially similar manner. These systems are often referred to collectively as the Global Navigation Satellite System (GNSS). Thus, for purposes of the disclosure herein, references to the GPS apply equally to the GNSS or to the individual systems which may be considered part of the GNSS.

It should also be noted that remote monitoring device 100a has no connection to the grid other than the reception of signals from the GPS 304. Since remote monitoring device 100a has no connection which allows communicating position information outside of remote monitoring device 100a, any positions determined using GPS receiver 102 or a combination of GPS receiver 102 and measurements from IMU 109 as processed by processor 110 would be stored locally in the memory of processor 110. This stored position information allows retrieving historical position (and other monitored) information during times that remote monitoring device 100 has no access to a communications network and may be retrieved later from RMD 100 either through a wireless connection using Cellular radio 104, Bluetooth radio 106, some other radio 108 (for example, Wi-Fi). Additionally, since in one embodiment RMD 100 includes computer port 111, that computer port may be used to download stored information and to upload configuration information such as sampling rate, active/inactive times, alarm thresholds on acceleration, velocity or location, or other parameters governing the operation of RMD 100.

Remote monitoring device 100b is illustrated as receiving GPS signals 403 from GPS satellites 304 using GPS receiver 102 as well as from the Cellular network 301 using Cellular radio 104. For example, Zhao describes several ways of estimating position based on Cellular radio signals (see Zhao, “Standardization of Mobile Phone Positioning for 3G Systems,” IEEE Communications Magazine, July 2002—The entire contents of which is incorporated herein by reference).

Remote monitoring device 100b may use either the GPS system 304 or the cellular system 301 to determine its position. The decision about which positioning system to use could be made by using processor 110 to calculate the error covariance matrices for both the GPS and cellular based position estimates. These error covariance matrices are then used to compute an estimate of the position error for each system. That positioning system with the smallest estimated error covariance would then be chosen by processor 110 for calculating the position of remote monitoring device 100b.

The GPS signals 403 received from the GPS satellites 304 and Cellular radio signals 404 received from the cellular network 301 can also be combined to yield a hybrid position estimate as described by Watters in U.S. Pat. No. 5,982,324, the entire contents of which is incorporated herein by reference. Other options for remote monitoring device 100b include the implementation of so-called cellular-assisted GPS (A-GPS). In such an embodiment, the cellular network provides time, frequency and other information to allow for improving the performance of GPS receiver 102. Such techniques are described in Van Diggelen, “A-GPS: Assisted GPS, GNSS and SBAS,” Artech House, 2006, the entire contents of which is incorporated herein by reference.

In addition to the ability of remote monitoring device 100b to use Cellular network signals 404 to provide cellular-based position estimates or to provide support for A-GPS position estimates, the cellular network signals 404 also provide a communications path for remote monitoring device 100b to send and receive information to other devices and servers on the grid by allowing access to Internet backbone 400 through cellular network 301. In this context, internet backbone 400 represents a connection to the internet using interfaces 402a or 402b which, in one embodiment are DSL and cable modems respectively. One of ordinary skill in the art would recognize that interfaces 402a and 402b could alternatively be implemented using interfaces to T1 links, T3 Links, SONET networks and other interfaces known in the art.

Remote monitoring device 100c illustrates another possible scenario for connecting to the grid. In this case, remote monitoring device 100c is able to receive GPS signals 403, cellular radio signals 404 and local area network signals 405 from local network 401b. In one embodiment, local network 405 is implemented as an ad hoc Wi-Fi network, also known as a mobile ad hoc network (or MANET), but could also be implemented as a Bluetooth, ZigBee or other wireless network. Thus, remote monitoring device 100c has all of the capability of remote monitoring device 100b (described above) and, additionally, is able to receive local area network signals 405 from local area network 401b. In the event that remote monitoring device 100c is not an authorized user of network 401b, the received signals may still provide positioning information that can be used by remote monitoring device 100b. In the event that remote monitoring device 100b is an authorized user of network 401b (or if network 401b is an unsecured access point), then remote monitoring device 100c may establish a communications path through network 401b.

In FIG. 4, local area network 401a represents a local area network of interconnected devices. As described above a local area network may, in general, consist of a variety of technologies known in the art. For example, local area network 401a could represent a Wi-Fi network. In this case, local network signals 405 are Wi-Fi signals and access points 408, such as the Linksys EA6500, can translate these Wi-Fi signals into wired signals which interconnect the individual nodes, or access points, of the local area network. In one embodiment, access points 408 are implemented using a wireless bridge, such as the D-Link DAP-1522, to allow the communications paths between access points to be either wired or wireless. The data communicated to or from local area network 401a is ultimately conveyed to the internet through router, bridge or modem 402b to allow data to be ultimately communicated through Internet backbone 400 between remote monitoring device 100 and server 204.

One of ordinary skill in the art would understand that since remote monitoring device 100 has the ability, when connected to the grid, to communicate with other devices attached to the internet, that remote monitoring device 100 would also be able to communicate with internet services such as Facebook, Foursquare, Groupon and the like via the appropriate APIs and setups. Since server 204 maintains knowledge of where each remote monitoring device 100 is located, such internet services can interface with server 204 to convey location-based information to users of remote monitoring device 100. Similar services could be used to convey information about coupons, discounts and the like to remote monitoring device 100 directly, or via server 204. Since remote monitoring device 100 may hold sensitive, personally identifying information about people or assets, server 204 and/or remote monitoring device 100 would support known security mechanisms to protect any sensitive information (for example, SSL, SFTP, HTTPS, AES encoding and the like.)

FIG. 4 illustrates four local area networks, 401a, 401b, 401c and 401d. One of ordinary skill in the art would understand that these may be of the same or of different technologies in any particular network deployment. For example, but without limitation, local area network 401a could be what is commonly known as a Wi-Fi network, network 401b could be a Bluetooth network, and network 401c could use another network technology (such as ZigBee, DECT, or other technology). Since each network may have specific requirements for attaching to other networks, links 402a-d represent the routers, hubs, switches, bridges, and other hardware and software as known in the art to allow communications between networks.

The grid 201 refers to the combination of all of the assets of FIG. 4. Thus, the concept of “connecting to the grid” or “plugging into the grid,” emerges. Within this concept, the grid provides two overlapping but distinct functions. The first function is that of position determination in which the approximate location of a remote monitoring device 100 can be determined not only directly, using the GPS satellites or the Cellular network as described above, but may also be determined by the proximity of remote monitoring device 100 to one or more local area network access points 408. The second function is that of communications using the resources of the grid (for example cellular radio or Wi-Fi).

Given this combination of resources, once a remote monitoring device 100 is connected to, or plugged into, the grid, it can collect position information which is either stored for later retrieval, or conveyed to server 204 periodically (for example, the data is regularly pushed to server 204 or server 204 regularly polls the device to receive data), asynchronously (for example, the data is pushed to server 204 or is polled by server 204 more randomly), or the data is retrieved directly using computer port 111.

Remote monitoring device 100c provides a good example of one of the main advantages of the grid concept. In this situation, the person or asset carrying remote monitoring device 100c may be travelling from an open area to a room inside an office building. While remote monitoring device 100c has GPS satellites 304 in view, an absolute position of remote monitoring device 100c can be determined by GPS receiver 102, and conveyed to server 204 once a connection to cellular network 301 has been established. As remote monitoring device 100c moves inside the office building, the signals from GPS satellites 304 will be degraded in signal strength and will be corrupted by multipath, making the information progressively less usable. In this case, as described above, position determination can continue using cellular network 301. As remote monitoring device 100c continues moving inside the building, cellular radio signals 404 will also degrade in signal strength and will be increasingly corrupted by multipath, making them less reliable for determining the position of remote monitoring device 100c. However, at this point, connection may be established with a node, or access point 408, of local area network 401a. By knowing which access point has established a connection with remote monitoring device 100c, it can be determined that remote monitoring device 100c is within an approximate circle centered on the access point maintaining the connection with remote monitoring device 100c.

Since establishing the approximate location of remote monitoring device 100 in this scenario uses the location of some or all of the access points being received, a database of access point locations is maintained in server 204 and/or in remote monitoring device 100. There are a number of suitable ways to determine access point locations including physically surveying locations, automatically surveying locations using the signaling among individual nodes in an ad hoc network to determine the topology of that network, scanning for signals and recording their position (also known as “war-driving”), or purchasing databases of access point information (for example from Skyhook Wireless).

Returning to FIG. 4, remote monitoring device 100d is shown connecting to two different local area networks 401a as well as cellular network 301. In this case, in addition to the cellular radio based techniques described above, remote monitoring device 100d has connections to two other wireless access points. By measuring range, angle of arrival and or signal strength to the nodes of the wireless networks, remote monitoring device 100d can determine its location relative to those nodes in addition to determining position using the cellular network. These position estimates can be combined in an optimal fashion using the techniques referenced above to yield an optimal estimate of the location of remote monitoring device 100d using, for example, multilateration, trilateration, triangulation alone, or in combination with inertial measurements from IMU 109.

Remote monitoring device 100e shows a case where no cellular signals 404 or GPS signals 403 are available. Instead, remote monitoring device 100e receives signals from access points 408 from network 401a and 401c. In this case networks 401a and 401b may use the same communications technology, for example, both may be Wi-Fi networks, or they may use different technology, for example, one might use Wi-Fi and the other might use Bluetooth. One of skill in the art would understand that a number of possible variations exist, and may be interconnected using suitable interconnections between networks 402a-d. As was the case with remote monitoring device 100d, by measuring range, angle of arrival and or signal strength to the nodes of the wireless networks remote monitoring device 100e can determine its location relative to those nodes in addition to determining position using the cellular network. These position estimates can be combined in an optimal fashion using the techniques referenced above to yield an optimal estimate of the location of remote monitoring device 100e using, for example, multilateration, trilateration, triangulation alone, or in combination with inertial measurements from IMU 109.

Remote monitoring device 100f shows a case where no cellular signals 404 or GPS signals 403 are available, but remote monitoring device 100f receives signals from multiple access points 408 associated with network 401d. Network 401d may, for example, use a communications technology such as Wi-Fi, Bluetooth, ZigBee or other suitable technology. As was the case with remote monitoring device 100e, by measuring range, angle of arrival and or signal strength to the nodes of the wireless networks remote monitoring device 100f can determine its location relative to those nodes in addition to determining position using the cellular network. These position estimates can be combined in an optimal fashion using the techniques referenced above to yield an optimal estimate of the location of remote monitoring device 100f using, for example, multilateration, trilateration, triangulation alone, or in combination with inertial measurements from IMU 109.

The implementations disclosed in FIG. 4 and the above discussion are intended merely to be exemplary and are not exhaustive. One of ordinary skill in the art would know that many additional permutations of received signals and network configurations are possible.

It is well known that the coverage area of an access point can be approximated by a circle centered on the access point maintaining the connection with remote monitoring device 100. The radius of this circle is a function of the power levels of each transmitter, the sensitivity of the receivers, objects in the environment that cause attenuation of the radio signals, reflections in the environment that cause multipath interference and other possible sources of interference. As a consequence of these effects, the actual radius and shape of this approximate circle varies significantly based on the characteristics of the operating environment and with the characteristics of the specific wireless system in use. For example, coverage area of cellular radio signals depends on cell site location, transmitter power and local terrain and typically ranges from 1 to 40 km, yielding a range for cellular signals 404 of from 500 meters to approximately 20 kilometers. Similarly, Wi-Fi signals have a range of approximately 100 meters, Bluetooth signals fall into different classes of operation and may have ranges between 1 and 100 meters.

The type of radio signal, and the geographic location and power level of the transmitter, is known at the time of licensing or installation (for example, the Federal Communications Commission maintains a database of licensed transmitters which includes the type of emission, power, height above average terrain, latitude, longitude and other information). Thus, knowing the type of network connection, and the identity of the node in the wireless network remote monitoring device 100 detects, the location of remote monitoring device 100 is known approximately since it must be located within the coverage area of the wireless node.

The process of determining position based on range to a network connection is illustrated in FIG. 5. FIG. 5 shows nodes 500a-c each located at a specific known location within area 502 e.g., a room. For example, node 500a is located at position (xₐ, yₐ) where xₐ denotes the location along the X axis of coordinate system 503 and yₐ represents the location along the Y axis of coordinate system 503. In FIG. 5 the origin of coordinate system is illustrated as being aligned with one edge of room 502 and the Y axis is shown aligned with an orthogonal edge of the room. In such a case, the (x, y) locations of nodes 500 may be expressed as offsets from a corner of the room (x=y=0). One of skill in the art would understand that there are many equivalent coordinate systems and that the (x, y) location of node 500 may be expressed in terms of latitude and longitude, offsets from a known reference point, UTM coordinates, or other coordinate system. Any convenient coordinate system may be used. In the event that different coordinate systems are used for different nodes 500, it would necessary to translate node positions into a common coordinate system for calculating the location of remote monitoring device 100 using techniques that are well-known in the art.

In order to determine the location of remote monitoring device 100, it is possible for remote monitoring device 100 to estimate the range 501 i.e., the distance, to one or more nodes 500. FIG. 5 illustrates a two-dimensional example where range estimates 501a-c are available between remote monitoring device 100 and each of nodes 500a-c. Each respective range measurement 501 defines a locus of points around a node 500. For example, range measurement 501a can be approximated as a circular region of radius rₐ around node 500a. Similarly, measurements 501b and 501c can be approximated by circular regions of radius r_{b} and r_{c} respectively. If the range measurements are exact, then it can be determined that remote monitoring device 100 is located at the intersection of the circles. If the range measurements are inexact, then the circles will not intersect at a single point but will overlap, resulting in a region of possible positions. The size of this region will depend on the quality of the range measurements.

The location of remote monitoring device 100 can be determined by solving for (x₁₀₀, y₁₀₀) in the system of simultaneous equations:

rₐ=\sqrt{(xₐ−x₁₀₀)²+(yₐ−y₁₀₀)²}

r_{b}=\sqrt{(x_{b}−x₁₀₀)²+(y_{b}−y₁₀₀)²}

r_{c}=\sqrt{(x_{c}−x₁₀₀)²+(y_{c}−y₁₀₀)²} (1)

In these equations (1), the ranges 501a-c corresponding to rₐ₁, r_{b1}, r_{c1} and the respective (x, y) positions of nodes 500a-c are known and either broadcast in the data transmitted by each node; retrieved from a database on, for example, server 204; or stored in memory associated with processor 110 (not shown). These equations may be solved for the unknown position (x₁₀₀, y₁₀₀) of remote monitoring device 100 by, for example, linearizing the equations by taking their Taylor series expansion and applying the Runge-Kutta method to iteratively determine an optimal solution for position (x₁₀₀, y₁₀₀). Other techniques as known in the art may be used as well. While this example is for a two-dimensional case, determining the position of remote monitoring device 100 in three dimensions, i.e. (x, y, z), merely requires including a z term in equations (1).

To determine ranges 501, one of skill in the art would know that these ranges could be determined using a variety of techniques known in the art, including measurement of time of arrival (TOA), time difference of arrival (TDOA), angle of arrival (AOA), received signal strength indicators (RSSI) and other techniques commonly used to determine range.

In general, the measured ranges 501 will not be exact, and therefore the circles determined by these ranges will not intersect at a single point, but rather will fall in a region surrounding remote monitoring device 100. This region is commonly referred to as an error ellipse which is used to quantify the accuracy of the calculated position. If nodes 500 are located in an indoor environment, one major source of inaccuracy in determining the position of remote monitoring device 100 results from errors estimating the ranges 501 between nodes 500 and remote monitoring device 100. These range measurement errors often result from the multipath reflections that occur from objects in the environment. Other sources of error include range errors due to poor time synchronization between nodes 500.

Although a typical practice in determining the location of a device, such as remote is monitoring device 100, is to attempt to determine its position as accurately as possible, there are a number of situations in which the solution of equations (1) is not necessary or desirable. In many circumstances, simply knowing that a connection exists between a remote monitoring device 100 and one or more nodes 500 that remote monitoring device 100 is connected to, is sufficient to approximate the location of the user if the approximate location of the one or more nodes 500 is known.

This situation is illustrated in FIGS. 6a and 6b in which remote monitoring device 100 is traversing a series of rooms 603 and hallways 604 within, for example, an office environment 600.

For example, FIG. 6a illustrates the situation that may exist when the nodes of the network are wireless access points inside a building. In this case, each access point 601 has a coverage area 602. These coverage areas 602 are represented as circular regions, however in general these regions may take on any shape due to the propagation characteristics (for example, attenuation and/or multipath) of the radio signals in a specific environment 600. In any particular environment, the number of access points and the location of each access point may vary to ensure the desired radio coverage of the environment.

The coverage areas 602 in environment 600 may, or may not overlap. For example, coverage areas 602a, 602b, 602d and 602e are shown as having at least some overlap while coverage regions 602c and 602f do not overlap any other coverage region. In general, each access point would be interconnected through an additional wired or wireless network which provides access to the Internet.

FIG. 6b illustrates remote monitoring device 100 traveling through environment 600 along path 605. Remote monitoring device 100 begins at a starting location A where it is within the coverage area of access point 601a. While at this point the precise location of remote monitoring device 100 cannot be determined, the connection of (or simply the detection of signals by) remote monitoring device 100 to access point 601a is sufficient to determine that remote monitoring device 100 is located within the coverage area 602a of access point 601a. Thus, remote monitoring device 100 can be determined to be in an area proximate to the location of access point 601a. As remote monitoring device 100 moves along path 605 it will eventually approach point B where coverage areas 602a and 602b overlap. At this location, remote monitoring device 100 can report the presence of access point 601b, allowing the position of remote monitoring device 100 to be refined. In this example, it is now possible to infer that remote monitoring device is moving towards access point 601b since that path is consistent with moving from coverage area 601a to coverage area 602b. Additionally, range measurements between remote monitoring devices 100 and access points 601a and 601b can also be used as described above to further refine the position estimate of remote monitoring device 100.

Continued movement of remote monitoring device 100 will result in losing contact with access point 601a as remote monitoring device 100 leaves the coverage area of access point 601a and enters an area covered only by access point 601b. As remote monitoring device 100 continues to move through environment 600 it encounters an overlap between coverage regions 602b and 602e when it senses the presence of access point 601e. In the example of FIG. 6b, there are two possible interpretations of this overlap region. One interpretation is that the remote monitoring device 100 followed the dashed portion of path 605 and entered room 603. An alternate interpretation is that remote monitoring device 100 followed the solid line of path 605 and continued down the hallway, crossing through point C. In one embodiment the path followed by remote monitoring device 100 can be displayed as an overlay on a map of the floor plan of the building.

Resolving these ambiguous paths is performed by server 204 which maintains information about the connections made by remote monitoring device 100 as well as information about the locations of access points 601 and their coverage areas 602 and a topology of the area. For example, as remote monitoring device 100 continues along the solid line path 605, it will lose contact with access point 601b, only detecting access point 601e. Had the dashed line path been followed, remote monitoring device 100 would not have lost contact with access point 601b. As remote monitoring device 100 can periodically detect signals for use in position determination, and can send these signals to server 204, remote monitoring device 100 can be tracked in real-time.

Additionally, based on the sequence of measurements made between remote monitoring device 100 and access points 601a, 601b and 601e, it is possible to predict the possible trajectories a user can follow or might be following. For example, server 204 can hypothesize that if remote monitoring device 100 follows hallway 606, that they will encounter access point 601d. Similarly, if remote monitoring device 100 follows hallway 604, then the server can hypothesize that remote monitoring device 100 will lose radio contact at point D and later detect signals from access point 601f at point E. Additionally, in areas such as point E where radio signals may not be available, IMU 109 can be used to estimate the motion of remote monitoring device 100 using dead reckoning. As remote monitoring device 100 moves, the position hypotheses and predicted paths will be refined as expected signals are either detected or not.

Thus, determining the location of remote monitoring device 100 does not rely on accurately determining the range between remote monitoring device 100 and multiple fixed points, but rather uses path planning techniques to generate hypothetical paths through environment 600 and uses whatever measurements are available (at whatever quality or accuracy level) to identify the most likely hypothesized paths. In one embodiment, this path determination is performed using tentacle based navigation, which is employed in robotic systems (see, for example, Himmelsbach, Michael, et al. “Autonomous off-road navigation for mucar-3.” KI-Künstliche Intelligenz 25.2 (2011): 145-149).

The position estimation algorithm described above was presented based on the motion of remote monitoring device 100 passing through an indoor environment. In general, the operating environment of the system resembles that of FIG. 4 in which portions of the path are outdoors where positioning methods such as GPS and cellular based positioning yields accurate positioning, transition areas between positioning systems where range errors may degrade positioning accuracy as well as indoor or urban wireless networks where the environment causes large errors in radio positioning.

FIG. 7 illustrates a system according to one embodiment of the current invention. Server 204 comprises one or more server computers which may be geographically distributed. Server 204 contains information to uniquely identify each remote monitoring device (for example, an International Mobile Equipment Identity, IMEI, or equivalent identification number), as well as information to uniquely identify the access points and other servers participating in grid 201 (for example a Medium Access Control, or MAC, address).

In the case of remote monitoring devices 100, the unique identification number is stored in a database accessible by server 204 such that an individual remote monitoring device 100 can be associated with, for example, an individual's name, a home address, an emergency contact telephone number, medical condition, or other information a user wishes to associate with a remote monitoring device. Other examples of data associated with a remote monitoring device might include rate of travel, temperature, acceleration, scheduled arrivals and departures from specified locations and the like.

Remote monitoring devices 100 connect to the grid 201 using the cellular telephone network or, if available, using a local area network such as Wi-Fi, Bluetooth or the like. When a remote monitoring device 100 connects to grid 201, it reports that connection to server 204 using, for example, a data connection established through the cellular telephone network. In the event that remote monitoring device 100 is located in a building 700 having wireless network access, a connection to server 204 may be established by passing first through one or more servers associated with the local network and subsequently connecting to server 204 using conventional wired or wireless communications.

Likewise, local area networks in urban areas or within buildings typically connect to grid 201 through a local server. This local server manages the access between the local network and the grid 201 and may contain local information about the individual local networks 700. In one embodiment, as a remote monitoring device 100 enters a local network 700, the server associated with local network 700 is configured to recognize and interact with remote monitoring devices 100 and thus may perform the position determination and tracking functions described above in order to distribute the processing load across the network. In this case, the server associated with location 700 can determine the position of each remote monitoring device 100 within its local network(s) and send the results of position determination to server 204 and/or track remote monitoring devices 100 to ensure that devices are not entering unauthorized areas. Server 204 can then record information about current location and status of each remote monitoring device 100, record historical information about each remote monitoring device 100, compare the location information about each remote monitoring device 100 to the predicted schedule of the user of each remote monitoring device 100, send alerts if a remote monitoring device 100 is entering an unauthorized area, send information about selected remote monitoring devices 100 to users authorized to view such information and the like.

FIG. 8 is a flowchart that illustrates the steps and interactions between each remote monitoring device 100 and the servers which allow devices 100 on the grid 201 to be tracked and monitored for a variety of purposes. As outlined above, the process begins at step 800 when a uniquely identifiable remote monitoring device senses the availability of a connection to the grid 201 via cellular radio, Wi-Fi, Bluetooth, or other wireless network connection. If remote monitoring device 100 senses the availability of a connection to grid 201, it initiates a connection request using one or more of the available communication mechanisms.

In step 801, server 204 (or other servers associated with networks 700) acknowledges the connection request from remote monitoring device 100. During this acknowledgement, data is exchanged between the remote monitoring device and the server(s) in the network. The data exchanged when a remote monitoring device 100 connects to the grid 201 would include, for example, information such as the unique identification number of remote monitoring device 100 as well as its current measured position, velocity, acceleration, status of battery charge, access points or cellular sites currently (or recently) heard, other measured data (such as temperature, heart rate, etc.) and the like. At this point in the process, the server(s) on the grid 201 have a rough knowledge of the position of remote monitoring device 100 by virtue of knowing the geographical location of the connection point. For example, in the case of a cellular connection, the location of individual transmitters is available through the license database maintained by the Federal Communications Commission. In the case of local networks 700, the position information would be determined when the access points are initially installed or would be determined by measuring the locations of the access points in the installed system.

Based on the information received from the remote monitoring unit 100, in step 802 server 204 and/or server 700 can generate hypotheses relating to the position of remote monitoring device 100. Initial candidate positions may be able to be generated based on any historical data received from remote monitoring device 100 (for example, if it was previously unconnected from the grid 201 and was collecting data using IMU 109).

In step 803, remote monitoring device 100 sends updated information to server 204 and/or server 700. This information relates to either a periodic update (at either a default rate, a rate selected based on the dynamics of remote monitoring device 100, or at a rate selected by server 204 or server 700), a scheduled update, or an update request from server 204 or server 700. This update provides server 204 and/or server 700 with information, such as position, velocity and acceleration, which is related to the current trajectory of remote monitoring device 100. Based on the information received from a remote monitoring device 100, server 204 and/or 700 can calculate a trajectory for remote monitoring device 100. Additionally, changes in parameters such as velocity or acceleration can be compared to expected values for a time or location of interest. For example, during school hours, a child carrying remote monitoring device 100 may be expected to be stationary, or moving at relatively low velocity, within school grounds. If the system senses that the remote monitoring device is moving at high speed, an alert may be generated to indicate the unexpected change in velocity (perhaps indicating unexpected travel in a vehicle).

Based on the data received in steps 801 and 803, server 204 and/or server 700 can compare the measured trajectory of remote monitoring device 100 with the hypothesized trajectories generated in step 802. Even in cases where the measurements made by remote monitoring device 100 are significantly in error, step 802 allows the search space of possible trajectories (paths) to be significantly reduced, leaving a relatively small number of possible paths for remote monitoring device 100. In step 804, the search space is reduced by eliminating the least likely hypotheses, retaining those most likely to contain the location of remote monitoring device 100.

In step 805, the remaining, most likely, paths capture information about the current location and the current path of remote monitoring device 100. If the data associated with remote monitoring device contains restrictions, such as remote monitoring device 100 being restricted to a certain area (known as geofencing), not arriving at a location on schedule, traveling in an unexpected location, and the like, then an alarm condition may exist. If there is a violation of an alarm condition, alarms 807 are triggered, resulting in messages being sent to predetermined destinations via e-mail, text messaging, telephone call as appropriate for the nature of the alarm. Another use of alarms 807 could also be to facilitate the provision of location based services. For example, as a driver carrying a remote monitoring device 100 approaches a service station for an appointment, a notification could be sent to the service station prior to the customer's arrival to enable more efficient service.

Regardless, once the comparisons of step 805 are complete, control flow returns to step 802 where the current hypotheses are updated and new hypotheses are generated based on the data received from remote monitoring device 100.

In the event that remote monitoring device 100 drops out of the coverage area of its current connection to grid 201, the process described in FIG. 8 restarts after a handoff to the next point connection to grid 201. When such a handoff occurs, it is possible to retain data and hypotheses from a previous connection in order to avoid recreating information that was previously calculated. In the event that a connection is lost for a period of time, it is possible that the last data received will become stale, therefore it may be necessary to consider weighting information from remote monitoring device 100 based on a timestamp to determine if the data is current (hot start), relatively current (warm start) out of date (cold start) and so on.

It should be recognized that the exchange of data between remote monitoring device 100 and server(s) 700 and/or server(s) 204, as well as the exchange of data between server(s) 700 and/or server(s) 204 and users may contain sensitive information which must be kept secure. For example, data from remote monitoring device 100 may contain information about particular individuals which must only be accessible to certain authorized users of the system. Likewise, remote monitoring device 100 may be transferring personally identifiable medical data and the like which must be protected from unauthorized access. The addition of multi-level security to computer systems is well known in the art and may be accomplished through the use of, for example, public key encryption, AES, 802.10 and other well-known techniques.

In remote monitoring device 100, processor 110 executes program code to initialize the devices present within remote monitoring device 100. For example, for the implementation illustrated in FIG. 1, processor 110 would initialize GPS Receiver 102, Cellular Radio 104, Bluetooth Radio 106, Other Radio 108, IMU 109 and computer Port 111. After initialization of the peripheral devices, the program code would set up a desired operational mode. For example, remote monitoring device 100 could be set in modes in which: 1) all peripherals are continuously operating, 2) only selected peripherals are operating, 3) one or more peripherals are periodically activated, and 4) activations occur based on an external event such as an increase in activity sensed by IMU 109, a change in activity pattern, or an alert from other sensor 115.

FIG. 9 is a flowchart that illustrates an exemplary operational flow which exercises the various features of remote monitoring device 100, some or all of which may be incorporated into any particular embodiment. In step 900 remote monitoring device 100 receives a wakeup signal based, for example on a change in acceleration, change in velocity, periodic interrupt, aperiodic interrupt based on time of day, schedule or the like. Receipt of a wakeup signal causes remote monitoring device 100 to enter step 901 where data from one or more of the peripheral devices in remote monitoring device 100 is read and stored in memory. In step 902, if GPS Receiver 102 is present and initialized, the GPS position of remote monitoring device 100 is read and stored in memory. Step 902 could optionally include receiving position, if available, via the cellular or other radio network.

In step 903 the available communications paths are identified. In this step, remote monitoring device 100 can determine the best way to establish a communications path for passing position-related information using grid 201. This determination can be based on, for example, received signal strength from available cellular, Wi-Fi, Bluetooth, or other networks; authorization to access a particular network; amount of power required to establish a network connection; connection bandwidth and similar factors. In step 904, once remote monitoring device 100 has determined the best communications path on grid 201, a communications between remote monitoring device 100 and servers 204 on grid 201 is established.

In step 905, remote monitoring device 100 exchanges authentication information with the servers on grid 201. If proper authentication is established, data about the status, location and other information as described above is passed to server(s) 700 and/or server(s) 204 in step 906. After data is exchanged between remote monitoring device 100 and the server(s) on grid 201, remote monitoring device 100 can enter a sleep mode 907 to conserve power.

Although FIG. 9 has been discussed in the context of remote monitoring device 100 waking up on the basis of an internal timer or timer interrupt, or based on external data received from other sensor 115 (or internal data received from IMU 109), it should be recognized that remote monitoring device 100 could also be woken up by a remote server accessing remote monitoring device 100 through Cellular Radio 104, Bluetooth Radio 106, Other Radio 108 and/or computer port 111.

The tracking device and remote monitoring system described herein has been presented with reference to exemplary embodiments which demonstrate how the location of a remote monitoring device can be determined to a useful level of accuracy without requiring any individual source of location information to have any particular level of accuracy. The approach described herein exploits the availability of a number of signals and measurements that are generally useful, and describes a heuristic method of combining these measurements in a way that allows position information to be maintained even in environments where conventional methods are normally not useful.

In addition to this heuristic approach to positioning, the tracking and monitoring device disclosed herein describes a number of types of data that may be collected for tracking, medical, asset management and other purposes.

Having thus described several features of at least one embodiment of the present invention, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A method of tracking a device, the method comprising:
receiving data from the device, the received data comprising detected signal and corresponding time information;
determining, as a function of the received data, a first position of the device at a corresponding first time;
determining, as a function of the received data, a second position of the device at a corresponding second time subsequent to the first time; and
determining a predicted position of the device, at a time subsequent to the second time, as a function of one or more of: the determined first and second positions, the first and second times and the determined topology.

2. The method of claim 1, further comprising:
determining a topology of an area including the first and second determined positions; and
determining the predicted position of the device as a function of the determined topology.

3. The method of claim 2, wherein the predicted position of the device is constrained by the determined topology and by characteristics of an entity to which the device corresponds.

4. The method of claim 1, further comprising:
determining a speed of the device as a function of one or more of: the determined first and second positions, the first and second times and the determined topology.

5. The method of claim 1, wherein the detected signal data comprises one or more of: Bluetooth signal data, Wi-Fi signal data, GPS signal data and cellular radio signal data.

6. The method of claim 1, further comprising:
receiving, from the device, data comprising one or more of: velocity, acceleration and activity level, of an entity associated with the device.

7. The method of claim 1, further comprising:
receiving, from the device, data comprising one or more of: pulse rate, blood pressure, blood oxygen level and blood glucose level of an entity associated with the device.
